(19) United States
(12) Patent Application Publication
(10) Pub. No.: US 2008/0266869 A1
(43) Pub. Date: Oct. 30, 2008

(54) LED module

(76) Inventors: Yun Tai, Taipei City (TW); Ruey-Feng Tai, Changhua City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,263

(22) Filed: Jul. 2, 2008

Related U.S. Application Data
(63) Continuation-in-part of application No. 11/519,956, filed on Sep. 13, 2006.

(51) Int. Cl. F21V 29/00

(52) U.S. Cl. 362/294

(57) ABSTRACT

A LED module includes a heat sink, which is partially oxidized to provide an oxidation layer and has a groove in a top recess thereof, and a plurality of mounting through holes cut through the top and bottom sides, a LED mounted in the groove of the heat sink, metal conduction plates fastened to the mounting through holes and extended to the outside of the heat sink, lead wires respectively connected between the metal conduction plates and positive and negative terminals of the LED, a light transmittance resin molded on the groove over the LED, and a lens holder fastened to the heat sink to hold an optical lens over the light transmittance resin.

### REFERENCE TO RELATED APPLICATION

This application is a Continuation-in-Part of patent application Ser. No. 11/519,956 filed 13 Sep. 2006, currently pending.

### BACKGROUND OF THE INVENTION

1. Field of the Invention

The present invention relates to a LED (light emitting diode) and more particularly, to a LED module that dissipates heat quickly during operation.

2. Description of the Related Art

In recent decades, human beings consume energy heavily, resulting in an energy crisis. Nowadays, scientists in different countries are trying hard to develop new energy and every-saving products. In consequence, various petroleum substitutes have been developed, the utilization of solar power has been enhanced, and various low power consumption type. fuel engines and motors and power-saving lighting fixtures have been created. Nowadays; LEDs (light emitting diodes) have been intensively used to substitute for conventional incandescent bulbs and fluorescent bulbs in various fields for the advantage of low power consumption.

The lower power consumption characteristic of LEDs is well known. Following fast development of semiconductor technology, high brightness LEDs are developed for use in many fields for illumination. For example, LEDs have been intensively used in motor vehicles for vehicle lights.

However, a LED must be packaged with a light transmittance resin before application. Because a high brightness LED releases much heat during operation and is enclosed in the package, heat cannot be quickly dissipated during the operation.

Various LED modules have been disclosed. Exemplars are seen in U.S. Pat. No. 6,531,328 B1, U.S. Pat. No. 6,874,910 B2, U.S. Pat. No. 6,943,433 B2, US Application No. US2005/0122720A1, and US Application No. US2006/0198147A1. However these designs are still not satisfactory in function, having drawbacks as follows:

With respect to U.S. Pat. No. 6,531,328 B1: silicon substrate is etched to form grooves for the installation of LED chip, and then silicon substrate is covered with surface insulator. After the insulative layer is grown, metal layer is plated. Meanwhile, back metal electrodes are formed. LED chip is placed on the electrode surface in the groove of silicon substrate. At the same time, bonding metal wire is made to connect electrode and encapsulating resin is dispensed. Similar to conventional designs, this LED packaging design is poor in heat dissipation. The fabrication of this packaging structure is complicated, resulting in a high cost. Further, because this packaging structure combines many different materials, the materials may separate from one another easily, causing damage.

With respect to U.S. Pat. No. 6,874,910 B2: radiator plate and insulating member are joined by adhesive. Radiator plate has projection. LED chip is bonded by die bonding paste to projection. Wiring pattern is extended along the side wall of insulating member. LED chips are electrically connected by bonding wires to wiring pattern at round recess of insulating member. Round recess and the through holes of projection are filled with sealing resin. According to the design of this light source device, heat energy is transmitted from LED chip downwards to radiator plate by projection for further dissipation. However, because the top side of radiator plate is covered by insulating member, radiator plate can only dissipate heat energy through its periphery and bottom side, resulting in low heat dissipation efficiency. Radiator plate and insulating member are two different materials joined by adhesive. This bonding procedure is difficult to achieve, increasing the cost. Further, because of high temperature, the bonding interface between radiator plate and insulating member may break easily, causing damage.

With respect to U.S. Pat. No. 6,943,433 B2: lead electrodes and heat sink are held and secured by package support part to support lead electrodes for the connection of electrodes of LED chip. LED chip is mounted on heat sink at the center and put in upper die and lower die, and then resin or glass fluid is filled in recess of package support part, and therefore LED chip is packaged. This semiconductor device has metal heat sink and resin package support part be bonded together. Heat sink is covered by resin package support part with only its bottom side left for dissipation heat. Therefore, this structure is less-efficiency in heat dissipation. Further, the connection interface between the two different materials of metal heat sink and resin package support part may break easily, shortening the service life of the LED.

With respect to US Application No. US2005/0122720A1: metal reflecting section is provided at recessed part of glass epoxy board, having light scattering particles. Semiconductor laser chip is installed in the bottom center of metal reflecting section and then packaged with epoxy resin that forms epoxy lens. This design is obvious to any person skilled in the art. This design is adapted to improve light projection efficiency with no help to improvement of heat dissipation efficiency. This design uses materials of low heat dissipation efficiency. When compared to metal, epoxy resin is inferior in dissipation of heat energy.

With respect to US Application No. US2006/0198147A1, it discloses a LED lamp cooling design. According to this design, LED chip is mounted on metal substrate with positive and negative electrodes of LED chip respectively connected to electrical conductive lager of circuit board at two sides of metal substrate by leads. Circuit board is provided with wires that are inserted through metal substrate, and insulation layer that isolates circuit board from metal substrate. Thermal glue is applied to bond heat dispersing flanges to heat sink. Based on this design, heat source is transmitted from LED chip by metal substrate to heat sink for dissipation. To prevent contact between electrode wires of LED chip and metal substrate, the complicated design of circuit board and insulation layer greatly complicates the manufacturing process of the LED lamp and also greatly increases its manufacturing cost.

### SUMMARY OF THE INVENTION

The present invention has been accomplished under the circumstances in view. It is therefore the main object of the present invention to provide a LED (light emitting diode) module, which dissipates heat quickly during the operation of the LED (light emitting diode). According to one embodiment of the present invention, the LED module comprises a heat sink, which has a top side oxidized to provide an oxidation layer, a top recess formed in the top side beyond the oxidation layer, a groove formed in the top recess and a plurality of mounting through holes cut through the top and bottom sides, a LED mounted in the groove of the heat sink, metal conduction plates fastened to the mounting through holes and extended to the outside of the heat sink, lead wires respectively connected between the metal conduction plates and positive and negative terminals of the LED, a light transmittance resin molded on the groove over the LED, and a lens holder fastened to the heat sink to hold an optical lens over the light transmittance resin. According to another embodiment of the present invention, the LED module comprises a heat sink, the heat sink having a top side oxidized to provide an oxidation layer and a top groove in the top side beyond the oxidation layer; a metal thin film covered on the top groove; at least one light emitting diode respectively fixedly on the metal thin film; a plurality of metal conduction plates affixed to the heat sink; a plurality of lead wires respectively connected between the metal conduction plates and positive and negative terminals of the at last one light emitting diode; and a light transmittance resin molded on the groove of the heat sink and covering the light emitting diode.

### BRIEF DESCRIPTION OF THE DRAWINGS

FIG. 1 is an exploded view of a LED module in accordance with a first embodiment of the present invention.

FIG. 2 is a sectional assembly view of the LED module in accordance with the first embodiment of the present invention.

FIG. 2A is similar to FIG. 2 but showing the LED mounted on a metal thin film on the groove in the top recess of the heat sink.

FIG. 3 is a perspective assembly view of the LED module in accordance with the first embodiment of the present invention.

FIG. 4 is an exploded view of a LED module in accordance with a second embodiment of the present invention.

FIG. 5 is a sectional assembly view of the LED module in accordance with the second embodiment of the present invention.

FIG. 6 is a perspective assembly view of the LED module in accordance with the second embodiment of the present invention.

FIG. 7 is an exploded view of a LED module in accordance with a third embodiment of the present invention.

FIG. 8 is sectional assembly view of the LED module in accordance with the third embodiment of the present invention.

FIG. 9 is a perspective assembly view of the LED module in accordance with the third embodiment of the present invention.

### DETAILED DESCRIPTION OF THE PREFERRED EMBODIMENT

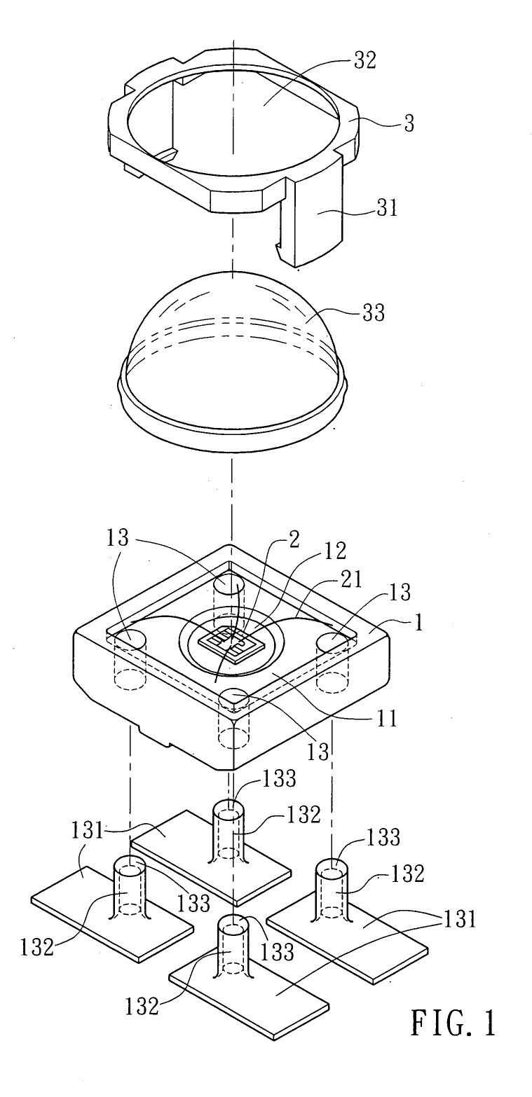

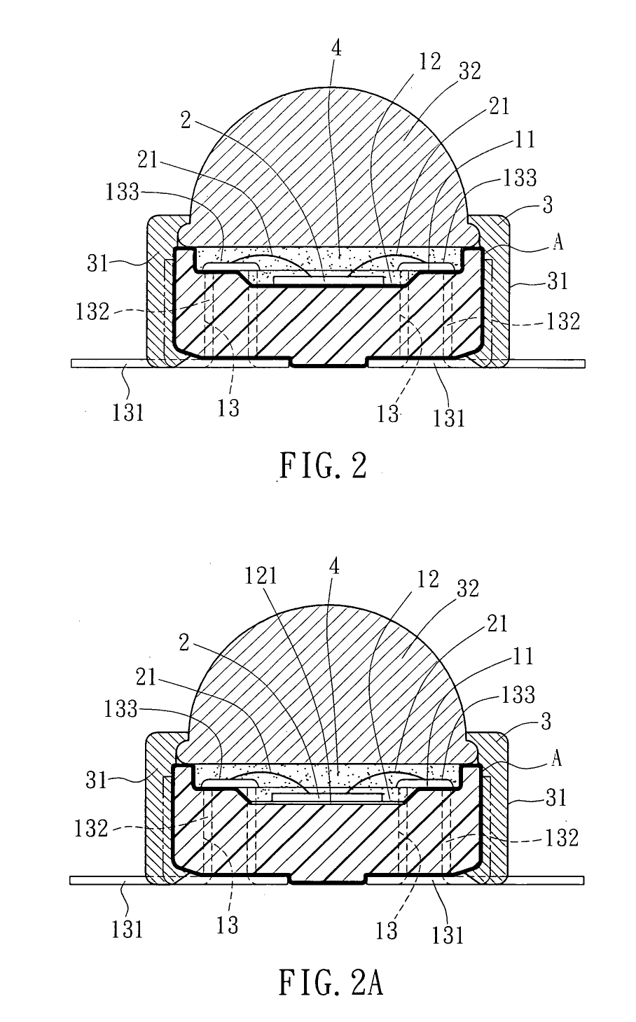

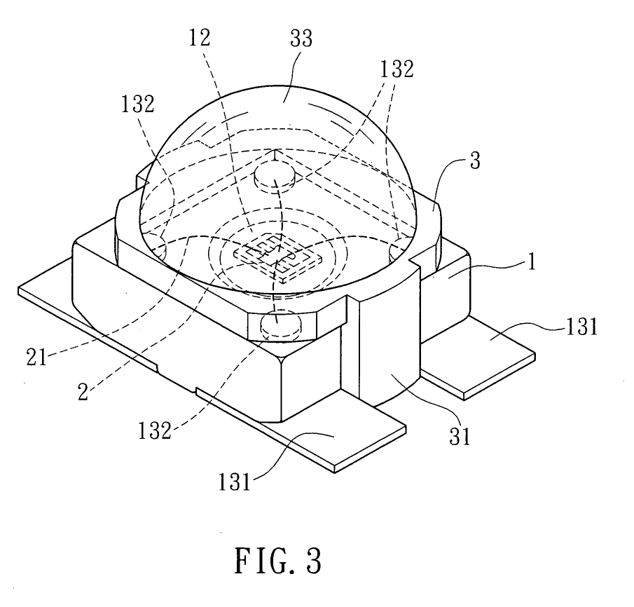

Referring to FIGS. 1˜3, a LED module in accordance with a first embodiment of the present invention is shown comprising a heat sink 1, a LED (Light Emitting Diode) 2 mounted in the heat sink 1, and a lens holder 3 fastened to the heat sink 1 and holding an optical lens 33 corresponding to the LED 2. The heat sink 1 has a top recess 11, a groove 12 formed in the top recess 11 for the mounting of the LED 2, and a plurality of mounting through holes 13 cut through the top and bottom sides. Further, the top surface of the heat sink 1 is covered with an oxidation layer A. Further, a plurality of metal conducting plates 131 are respectively fastened to the heat sink 1. The metal conducting plates 131 each have an upright shank 132 respectively inserted from the bottom side of the heat sink 1 into the mounting through holes 13. After insertion of the upright shanks 132 into the mounting through holes 13, the top ends 133 of the upright shanks 132 are hammered down to affix the upright shanks 132 to the heat sink 1. Further, lead wires 21 are respectively connected between the positive and negative electrodes of the LED 2 and the upright shanks 132 of the metal conducting plates 131. A light transmittance resin 4 is molded on the top recess 11 over the LED 2, keeping the LED 2 embedded in the light transmittance resin 4. The lend holder 3 has a plurality of bottom hooks 31 respectively hooked on the bottom edge of the heat sink 1, and a center opening 32. The optical lens 33 is fastened to the center opening 32 of the lens holder 3. The heat sink 1 is made out of a metal material, for example, gold, silver, copper, iron, aluminum, or their alloy that transfers heat energy efficiently. Further, a metal thin film 121 may be directly bonded to the groove 12 that is not covered by the oxidation layer A so that the LED 2 can be directly fastened to the metal thin film 121. During the operation, heat energy is quickly transferred from the LED 2 to the heat sink 1 through the metal thin film 121 (see FIG. 2A). The metal thin film 121 can be a film of nickel gold alloy, nickel silver alloy, or nickel copper alloy.

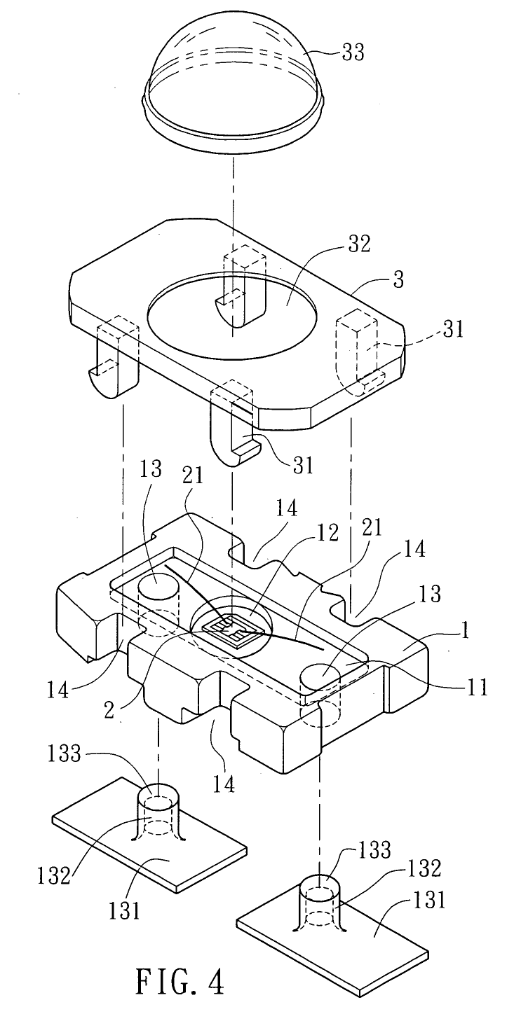

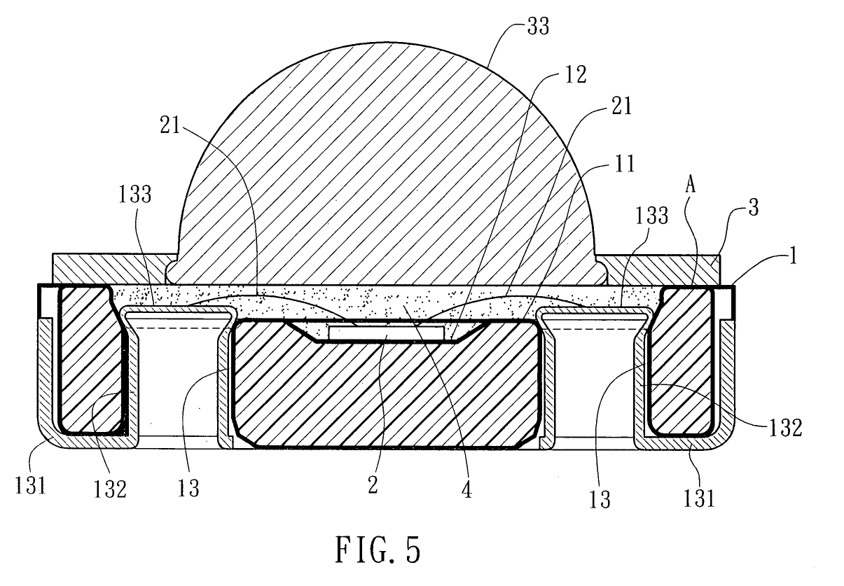

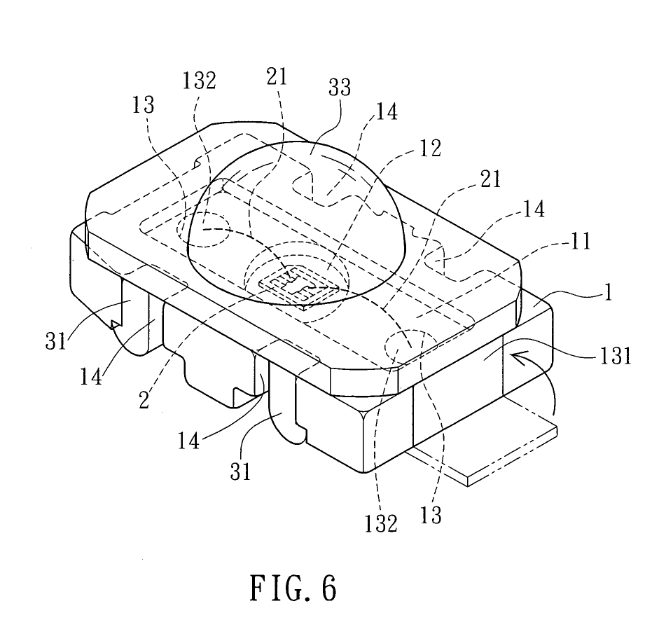

FIGS. 4˜6 show a LED module in accordance with a second embodiment of the present invention. This embodiment is substantially similar to the aforesaid first embodiment with the exception that the heat sink 1 has a plurality of peripheral notches 14 for securing the bottom hooks 31 of the lens holder 3. Further, the heat sink 1 has only two mounting through holes 13 for the mounting of two metal conducting plates 131.

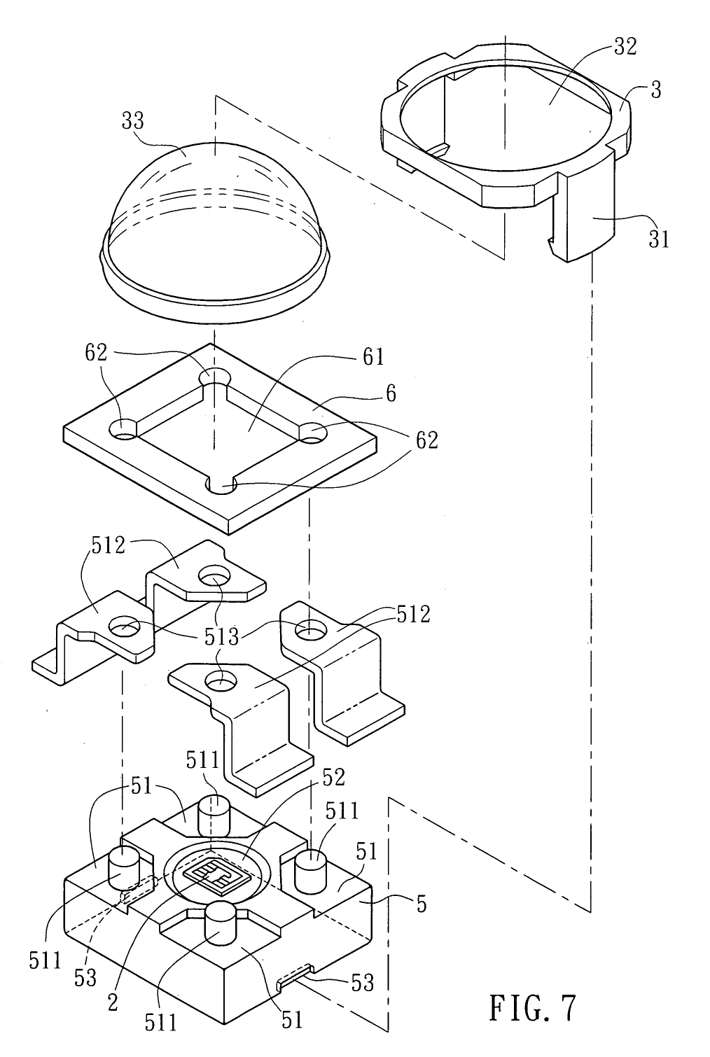

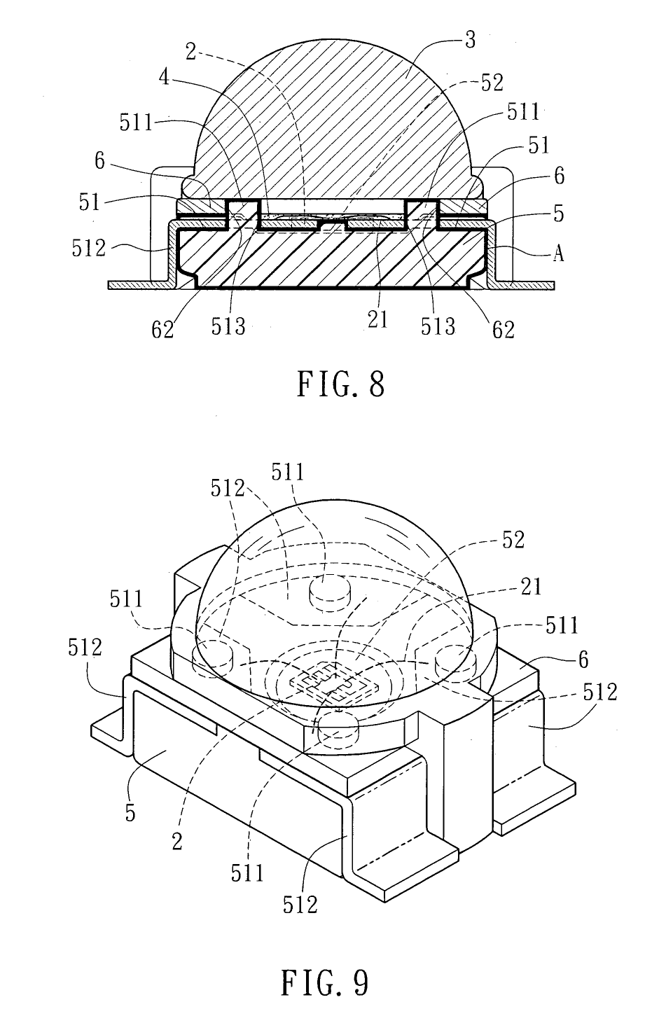

FIGS. 7˜9 show a LED module in accordance with a third embodiment of the present invention. According to this embodiment, the LED module comprises a heat sink 5, a LED (Light Emitting Diode) 2 mounted in the heat sink 5, and a lens holder 3 fastened to the heat sink 5 and holding an optical lens 33 corresponding to the LED 2. The heat sink 5 has a top center recess 52 for the mounting of the LED 2, a plurality of top border recesses 51 spaced around the top center recess 52, an upright rod 511 respectively disposed in each top border recess 51, and a plurality of peripheral bottom notches 53. Further; the top surface of the heat sink 5 is covered with an oxidation layer A. Further, a plurality of metal conducting plates 512 are respectively fastened to the top border recesses 51 of the heat sink 5 and extended to the periphery of the heat sink 5. The metal conducting plates 512 each have a vertical through hole 513 respectively coupled to the upright rod 511. Further, lead wires 21 are respectively connected between the positive and negative electrodes of the LED 2 and the metal conducting plates 512. A light transmittance resin 4 is molded on the top side of the heat sink 5 over the LED 2, keeping the LED 2 embedded in the light transmittance resin 4. The lend holder 3 has a plurality of bottom hooks 31 respectively hooked on the peripheral bottom notches 53 of the heat sink 5, and a center opening 32. The optical lens 33 is fastened to the center opening 32 of the lens holder 3. Further, a locating frame 6 is sandwiched between the heat sink 5 and the lens holder 3, having a center opening 61 corresponding to the center opening 32 of the lens holder 3, and a plurality of inside notches 62 that accommodate the upright rods 511 respectively.

In the aforesaid embodiments, the lens holder 3 and the optical lens 33 are two independent members. Alternatively, the optical lens 33 can be formed integral with the lens holder 3. If desired, the lens holder 3 and the optical lens 33 can be eliminated from the LED module. Further, the LED module can be made carrying two or more LEDs 2.

As stated above, heat sink 1 has its surface processed to form an oxidation layer A. This oxidation layer A is not formed by covering the surface of heat sink 1 with a resin. It is formed by oxidizing the surface of heat sink 1. Because oxidation layer A is formed by oxidizing the surface of the metal material of heat sink 1, the invention eliminates the drawback of the application of a complicated prior art processing procedure to form a layer of resin insulator on a metal substrate or heat sink, and LED 2 can easily and quickly be connected to the metal conducting plate 131 without causing short circuit. Because the surface of heat sink 1 and the surface of each mounting through hole 132 of the metal hint sink 1 have an insulation layer, i.e., the oxidation layer A, installation of LED 2 in groove 12 or insertion of upright shanks 132 of metal conducting plate 131 through mounting through holes 13 does not cause short circuit between electrodes, facilitating quick fabrication of the LED module and lowering the manufacturing cost of the LED module. This invention employs an anodic treatment to a metal substrate to form an oxidized insulation layer on the surface of the metal substrate, and then covers a metal conducting layer on the oxidized insulation layer at selected locations for the mounting of lead wires and electronic devices. According to the invention, the oxidized insulation layer is formed by means of the application of a DC voltage to oxidize the surface of the metal substrate under a low temperature environment. The oxidized insulation layer has high temperature and high pressure resisting characteristics. Direct stamping of the metal substrate does not destruct the oxidized insulation layer. By means of the application of a DC voltage 0V˜25V (not pulse) to perform low temperature electrolytic oxidation, the oxidized insulation layer has fine surface wick structure, showing smooth and hard characteristics. When stamping the metal substrate, the surface of the oxidized insulation layer does not break (the surface is temperature, pressure and electricity resistant), preventing a short circuit. A heat conducting substrate prepared from aluminum is relatively flexible. During a stamping process, the aluminum substrate may deform, and the oxidized surface layer that is formed by means of an anodic treatment may break.

Although particular embodiments of the invention have been described in detail for purposes of illustration, various modifications and enhancements may be made without departing from the spirit and scope of the invention.

What the invention claimed is:

1. A LED module comprising:
a heat sink, said heat sink having a top side oxidized to provide an oxidation layer, a top recess formed in said top side beyond said oxidation layer, a groove formed in said top recess, and a plurality of mounting through holes cut through top and bottom sides thereof and spaced around said groove;
at least one light emitting diode respectively fixedly mounted in said groove of said heat sink;
a plurality of metal conduction plates affixed to said heat sink at a bottom side, said metal conducting plates each having an upright shank respectively affixed to the mounting through holes of said heat sink;
a plurality of lead wires respectively connected between said metal conduction plates and positive and negative terminals of said at last one light emitting diode; and
a light transmittance resin molded on said groove of said heat sink and covering said light emitting diode.

2. The LED module as claimed in claim 1, further comprising a lens holder fastened to said heat sink to hold an optical lens over said light transmittance resin, said lens holder having a plurality of bottom hooks respectively hooked on a bottom edge of said heat sink.

3. The LED module as claimed in claim 2, wherein said lens holder has a center opening for accommodating said optical lens.

4. The LED module as claimed in claim 1, wherein said oxidation layer covers the whole surface area of said heat sink around said recess.

5. The LED module as claimed in claim 1, wherein said heat sink is made of a metal material of high coefficient of heat transfer.

6. The LED module as claimed in claim 1, further comprising a lens holder fastened to said heat sink, said lens holder having a plurality of bottom hooks respectively hooked on a bottom edge of said heat sink, and an optical lens formed integral with said lens holder and covered over said light transmittance resin.

7. A LED module comprising:
a heat sink, said heat sink having a top side oxidized to provide an oxidation layer, a top groove formed in said top side and surrounded by said oxidation layer;
a metal thin film covered on said top groove;
at least one light emitting diode respectively fixedly on said metal thin film;
a plurality of metal conduction plates affixed to said heat sink;
a plurality of lead wires respectively connected between said metal conduction plates and positive and negative terminals of said at last one light emitting diode; and
a light transmittance resin molded on said groove of said heat sink and covering said light emitting diode.

8. A LED module comprising:
a heat sink, said heat sink having a top side oxidized to provide an oxidation layer, a top center recess formed on said top side, a plurality of top border recesses formed on said top side and spaced around said top center recess, and a plurality of upright rods respectively upwardly extending from said top side in said top border recesses;
at least one light emitting diode respectively fixedly mounted in said top center recess;
a plurality of metal conduction plates respectively fastened to the top border recesses of said heat sink, said metal conducting plates each having a vertical through hole respectively fastened to said upright rods of said heat sink;
a plurality of lead wires respectively connected between said metal conduction plates and positive and negative terminals of said at last one light emitting diode; and
a light transmittance resin molded on said groove of said heat sink and covering said light emitting diode.

9. The LED module as claimed in claim 8, further comprising a lens holder fastened to said heat sink and holding an optical lens over said light transmittance resin.

10. The LED module as claimed in claim 9, further comprising a locating frame sandwiched in between said lens holder and said heat sink, said locating frame having a center opening corresponding said light transmittance resin and a plurality of inside notches that accommodate said upright rods of said heat sink respectively.

11. The LED module as claimed in claim 8, wherein said heat sink is made of a metal material of high coefficient of heat transfer.

12. The LED module as claimed in claim 8, further comprising a lens holder fastened to said heat sink, said lens holder having a plurality of bottom hooks respectively hooked on a bottom edge of said heat sink, and an optical lens formed integral with said lens holder and covered over said light transmittance resin.
